(19) United States
(12) Patent Application Publication
(10) Pub. No.: US 2003/0128902 A1
(43) Pub. Date: Jul. 10, 2003

(54) Snap together thrust and journal bearing assembly

(75) Inventor: Lawrence C. Kennedy, Bingham Farms, MI (US)

Correspondence Address: Bill C. Panagos, Senior Patent Counsel, Detroit Diesel Corporation, 13400 Outer Drive, West, Detroit, MI, 48239-4001, US

(73) Assignee: Detroit Diesel Corporation

(21) Appl. No.: 10/042,036

(22) Filed: Jan. 10, 2002

(51) Int. Cl. F16C 17/00

(52) U.S. Cl. 384/275; 384/294

(57) ABSTRACT

A thrust and journal bearing assembly is presented that provides for separate thrust and journal segments that are joined together and held in place by interlocking tabs and slots.

### BACKGROUND OF THE INVENTION

The present invention relates to a crankshaft thrust and journal bearing assembly for internal combustion engines, featuring interlocking tabs and slots located to cooperatively engage tabs located on the thrust bearing segments to snap into slots in the journal bearing shell to present a snap together thrust and journal bearing that is held in place without the use of locating pins or dowels.

The present invention further relates to an easy to assemble thrust and journal bearing assembly that is both inexpensive to manufacture and assemble, and durable in use.

The present invention further relates to a three-piece interlocking thrust bearing assembly to provide a securely connected, floating assembly for use with crankshafts in internal combustion engines.

### SUMMARY OF THE INVENTION

Internal combustion engines typically feature one or more crankshafts, the crankshaft(s) serving to transform the linear motion of the pistons to rotary motion. Pairs of thrust bearings typically restrain the axial movement of the crankshaft(s), either separate from one of the journal bearings that serve to support the crankshaft, or as an integral part of its assembly. The latter is generally referred to as a flanged thrust bearing. It has the advantage over separate thrust bearings of not requiring dowel pins or other locating/retention features. Its shortcomings are (1) crowning in the circumferential direction of each segment of the thrust bearing, to promote formation of load-carrying hydrodynamic films, is not feasible according to bearing manufacturer, and (2) reduction of bearing thrust capacity resulting from bearing deflection under thrust loading. The flanges deflect because of the slight axial clearance that is necessary to facilitate assembly between the flange bearing backs and machined block counter bore faces. This deflection has also been known to result in fatigue cracking of the bearing. The present invention combines the best of both conventional bearing designs by allowing separate manufacture of the journal and thrust bearings and them providing a securely connected, floating three piece bearing assembly.

The present invention is directed to a novel thrust and journal bearing assembly for use in machined surfaces of an engine cylinder block. The assembly is comprised of at least two arcuate thrust bearing segments, each having an outer arcuate surface and an inner arcuate surface in spaced concentric relationship to each other and separated by a sidewall extending substantially unbroken therebetween to define a thrust bearing segment body. Each thrust bearing body has a length terminating in opposing first and second ends, a width and a height. Each thrust bearing segment outer arcuate surface has an outer diameter and an inner arcuate surface having an inner diameter that is less than said thrust bearing segment outer diameter. Each inner arcuate surface is equipped with at least one body flange extending therefrom opposite the outer arcuate surface. The arcuate thrust bearing segment is further equipped with a first flange at the first end, and a second flange at said second end of the segment body.

The assembly further includes an arcuate journal bearing shell having an outer arcuate surface and an inner arcuate surface in spaced concentric relationship to each other and separated by a sidewall extending substantially unbroken therebetween to define a journal bearing segment body. The journal body segment has a length terminating in opposing first and second ends, a width and a height. The journal bearing segment outer arcuate surface has an outer diameter less than the outer diameter of the thrust bearing and slightly less than the inner thrust bearing diameter. The journal bearing segment inner arcuate surface has an inner diameter less than said journal bearing segment outer diameter. The journal bearing body is further equipped with slots positioned along the length of said journal body oriented to cooperatively engage said flanges on each said thrust bearing. The thrust body segments and the journal bearing shell are elastically deformable whereby, the thrust segments may be snap fit onto said journal bearing and the flanges cooperatively engage the slots on each side of the journal bearing shell to locate the thrust bearing in relation to the journal bearing.

### BRIEF DESCRIPTION OF THE DRAWINGS

FIG. 1 is a three-dimensional perspective view of the thrust and journal bearing assembly prior to assembly.

FIG. 2 is a three-dimensional perspective view of the thrust and journal bearing assembly after assembly.

FIG. 3 is a side view of the thrust and journal bearing during assembly

FIG. 4 is a cut away side view of the thrust and journal bearing taken along line 4-4 of FIG. 2.

FIG. 5 is a detail view of the interaction of the slots and tabs of FIG. 3.

FIG. 6 is a detailed view of the interaction of the tabs on the thrust bearing segment with the journal bearing shell of FIG. 2.

### DETAILED DESCRIPTION OF A PREFERRED EMBODIMENT

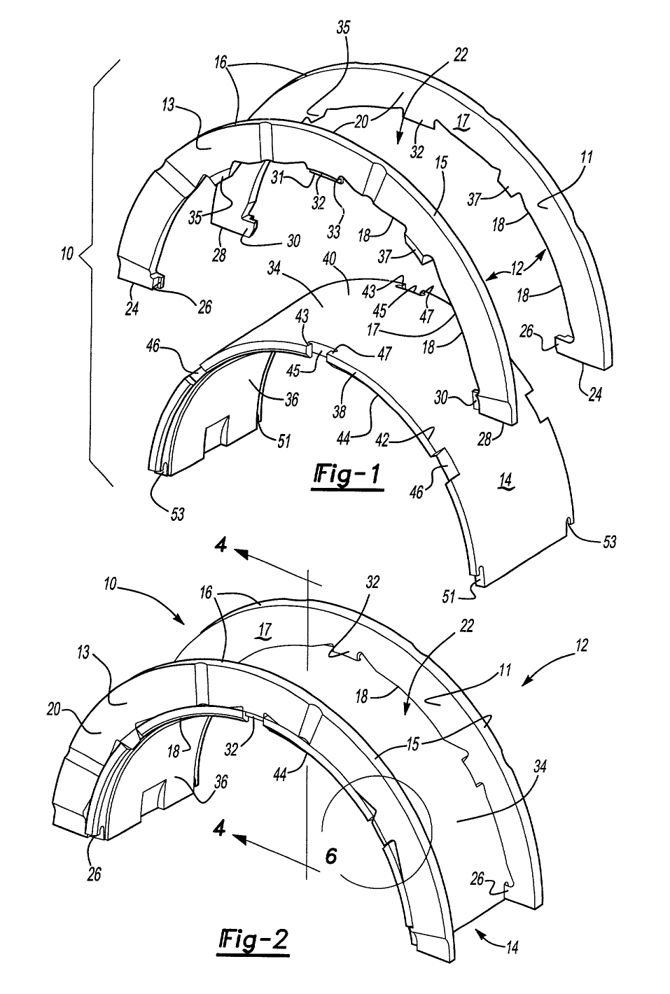

Turning now to the drawings, wherein like numeral refer to like structures, and particularly to FIG. 1, thrust journal bearing assembly 10 is comprised of at least one, and preferably two, thrust bearing segments 12 and a journal bearing shell 14. Each thrust bearing segment has an arcuate outer diameter surface 16 of a determinate length, which forms an outer diameter 15 of the thrust bearing segment, and an arcuate inner diameter surface 18 of a determinant length, which forms the inner diameter 17 of the thrust bearing segment. These arcuate diameter surfaces are concentric with each other, and the outer arcuate diameter is larger than the inner arcuate diameter. A sidewall 20 extends substantially unbroken therebetween to define the thrust bearing segment body 22. Accordingly, each thrust bearing segment body has a length, width and height. Each thrust body segment has opposing ends and terminates at one end 24 by a first flange 26, and terminates at a second end 28 by a second flange 30. Flange 30 extends circumferentially longer than flange 26, so that assembly is only possible in the correct orientation. Midpoint along the length of each thrust body segment is a midpoint flange 32. Flange 32 depends from the inner arcuate surface and extends opposite the outer diameter surface. The midpoint flange has a stepped construction so that key 33 depends from planar rest 31 to define the flange 32. It will be appreciated that additional flanges 35 and 37 in spaced relationship midpoint between flanges 26 and 32, and 30 and 32, respectively, may depend from inner arcuate surface 18, as required by design needs. In addition, each of the flanges is oriented such that they are recessed from outer sidewall surface 13, and extend coplanar with inner sidewall surface 11 of the thrust bearing segment. This orientation and construction of the flanges is particularly important with regard to the interaction of the midpoint flange 32 and the slots in the journal shell, as will become apparent in the discussion directed to FIG. 2.

The journal shell 14 is comprised of a journal outer arcuate surface 34, and a journal inner arcuate surface 36 in spaced concentric relationship, separated by a sidewall 38 extending substantially unbroken therebetween to define a journal body segment 40. The journal outer arcuate surface has a journal outer segment outer diameter 42 that is slightly less than the thrust bearing inner diameter. The journal inner arcuate surface forms a journal segment inner diameter 44 that is less than the journal bearing segment outer diameter. The journal bearing body is equipped with slots 46 positioned along the perimeter of the journal body oriented to cooperatively engage the flanges on the thrust bearing segments. Indeed, the Figure depicts four such slots, there being two on each side of the journal bearing shell. The thrust and journal bearing assembly is designed for use in an internal combustion engine that has a machined surface to receive a thrust and journal bearing. A pair of slots, designated as 45, at opposing peripheral apexes of the journal bearing shell are each equipped with retaining flanges 43 and 47. These flanges engage the key 33 of flange 32 to retain the thrust bearing segment in the desired position on the journal body shell.

Usually, a thrust and journal bearing is seated in close proximity to the main bearing cap of a crankshaft. The slots and the flanges engage each other with sufficient axial clearance so that the journal bearing assembly maintains full contact with the machined surfaces of the engine block and the main bearing cap.

Ideally, the thrust segments and journal bearing shell are made of an elastically deformable material such as steel. The flanges on the thrust segments are chamfered to facilitate cooperative engagement between the thrust bearing segment and the journal bearing shell.

The thrust bearing segments and the journal shell bearing are made of an elastically deformable material, such as steel. The thrust bearing flanges have an allowable deflection as approximately determined by the formula for a straight cantilevered beam of rectangualr cross section:

S_{yp}=Mc/I

c=h/2

M_{yp}=S_{yp}I/c

l=πdₘ/4

P_{yp}=M_{yp}/l

y_{yp}=P_{yp}l³/3EI

wherein

S_{yp} is the yield point stress

M is the moment

c is ½ the height (h)

I is the moment of inertia

h is the height

l is the length of a half thrust bearing segment

dₘ is the mean thrust segment diameter

P_{yp} is the force at yield point

y_{yp} is the deflection at yield point

E is the modulus of elasticity, and

Similarly, the Journal shell bearing has a maximum deflection as set forth in the formula

y=P_{yp}l³/3EI

wherein

y is the deflection;

I is the moment of inertia;

l is the length; and

E is the modulus of elasticity.

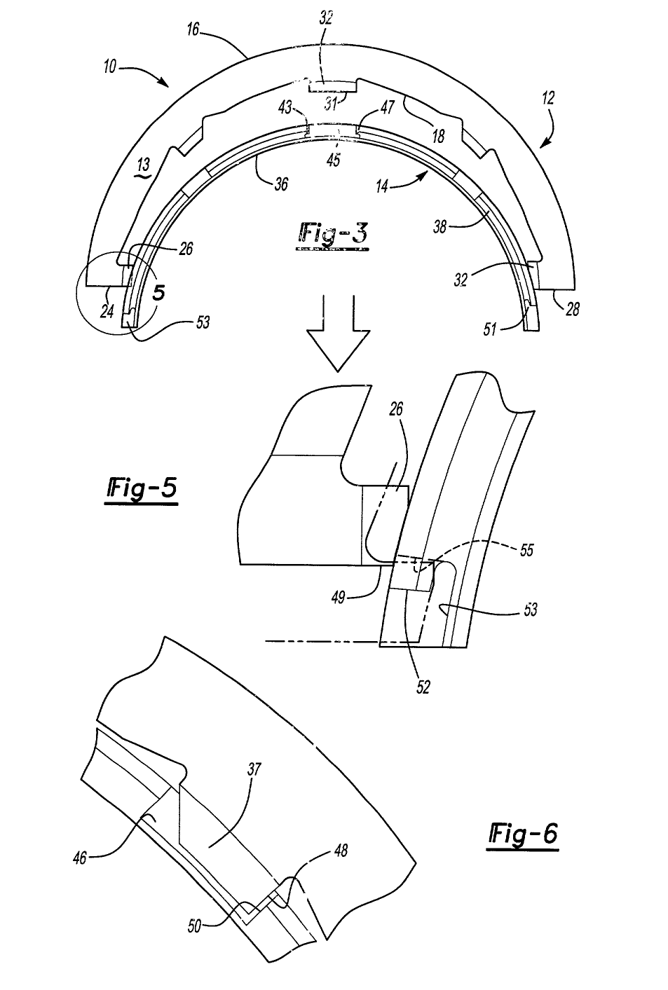

Turning now to FIG. 3, during assembly, each thrust bearing segment terminal flanges would deflected outwardly and the journal shell would be compressed slightly until the flanges on the thrust segment cooperatively engage the slots, wherein the thrust bearing segment would spring to its uncompressed configuration and the journal shell would spring back from its deflected state and hold the bearing assembly together as it expands to its normal configuration. As previously stated, the journal outer diameter is slightly smaller than the thrust bearing inner diameter, and less than the thrust bearing segment outer diameter. Thus, when the thrust bearing segment is pressed into place over the journal bearing shell, the compressive force is released from the journal shell and an expansive force is released from the thrust bearing segment. Once the thrust bearing segment is in place, the tabs engaging the slots hold the assembly in place after the tabs on the thrust segment have engaged the slots.

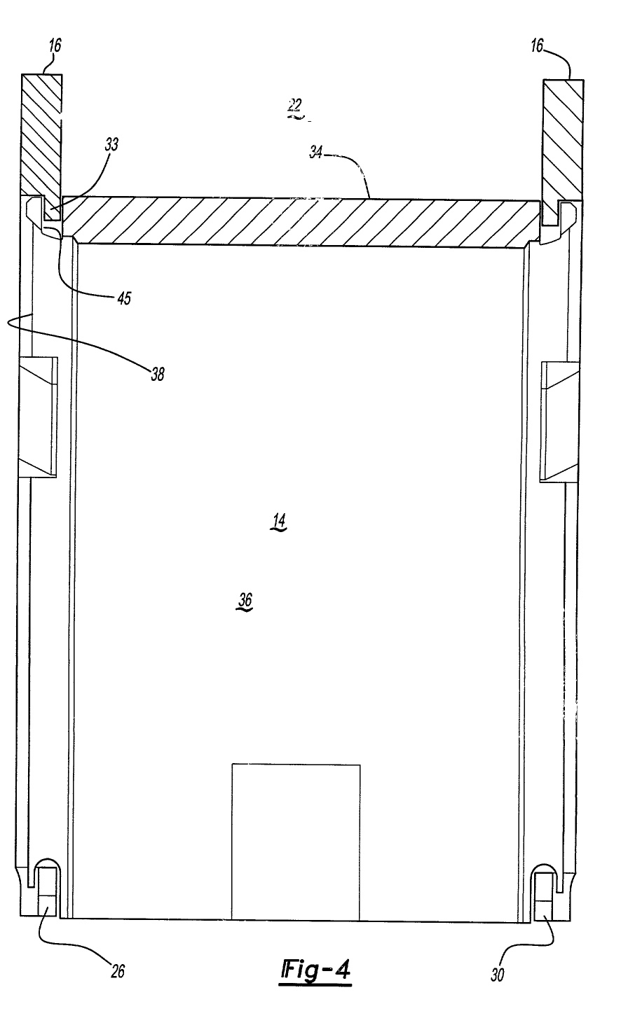

FIG. 4 is a cut away view of the thrust and journal bearing assembly of FIG. 1 taken along line 4-4 depicting the interaction of the flanges 32 and the slot 45. As previously stated, the key 33 of the flange interacts with the slot 45 and retaining flanges 43 and 47 to position the thrust bearing segments on the journal bearing shell.

FIG. 5 is a detailed view of the interaction of flange 26 with slot 53, taken at circle 5 as seen on FIG. 3. Specifically, as the journal shell bearing is deformed and the thrust bearing segment is expanded, flange 26 is positioned into slot 53 along movement line 49. When the deformation forces are released from the thrust bearing segment and the journal shell, flange 26 is snap fit into slot 53. Note that the flange has a stop 55 that cooperatively engages surface 52 of slot 53 to limit forward movement of the thrust bearing segment relative to the journal bearing segment. It is understood that flange 30 and slot 51 have mirror image structure and interaction as flange 26 and slot 53. Slot 53 is longer than slot 51 to facilitate proper assembly of the bearing.

Turning now to FIG. 6, which is a detail of the circle 6 of FIG. 2, there is depicted therein the flange 37 and its interaction in slot 46. The flange is configured to have a stop 48, oriented such that when forces on the thrust and journal bearing assembly are in one direction, that force drives the stop against the wall 50 of the slot such that the interaction of stop and wall halts all forward movement of the thrust bearing segment relative to the journal bearing segment. It is to be understood by those of ordinary skill in the art that flange 35 has a mirror image as flange 37 and slot 46 configuration which cooperatively engages the side wall of its slot to halt movement of thrust bearing segment in the other direction.

While one embodiment has been discussed, those skilled in the art recognize that there are many variations are possible, and the description given herein is not to be construed as limiting in any way the scope and spirit of the invention as set forth in the appended claims.

We claim:

1. A thrust and journal bearing assembly for use in machined surfaces of an engine cylinder block, comprising:
a) at least two arcuate thrust bearing segments, each having an outer arcuate surface and an inner arcuate surface in spaced concentric relationship to each other and separated by a sidewall extending substantially unbroken therebetween to define a thrust bearing segment body; each said thrust bearing body having a length terminating in opposing first and second ends, a width and a height; each said thrust bearing segment outer arcuate surface having an outer diameter; each said thrust bearing segment inner arcuate surface having an inner diameter less than said thrust bearing segment outer diameter; said inner arcuate surface equipped with at least one body flange extending therefrom opposite said outer arcuate surface, said arcuate thrust bearing segment equipped with a first flange at said first end, and a second flange at said second end;
b) an arcuate journal bearing shell having an outer arcuate surface and an inner arcuate surface in spaced concentric relationship to each other and separated by a sidewall extending substantially unbroken therebetween to define a journal bearing segment body; said journal body segment having a length terminating in opposing first and second ends, a width and a height; said journal bearing segment outer arcuate surface having an outer diameter less than the outer diameter of the thrust bearing and less than the inner thrust bearing diameter; said journal bearing segment inner arcuate surface having an inner diameter less than said journal bearing segment outer diameter; said journal bearing body equipped with slots positioned along the length of said journal body oriented to cooperatively engage said flanges on each said thrust bearing;
whereby, said thrust segments may be snap fit onto said journal bearing and the flanges cooperate with the slots to locate the thrust bearing in relation to the journal bearing.

2. The thrust and journal bearing assembly of claim 1, wherein said thrust bearing body flange is located midpoint along said thrust bearing body length.

3. The thrust and journal bearing assembly of claim 1, wherein said journal and thrust bearing are elastically deformable.

4. The thrust and journal bearing assembly of claim 1, wherein the slots and flanges engage each other with sufficient axial clearance so that the journal bearing maintains full contact with the machined surfaces of the engine block and the main bearing cap.

5. The thrust and journal bearing assembly of claim 1, wherein a lower perimeter is formed by the intersection of the journal bearing shell sidewall and the journal body outer surface; said slots formed along the perimeter of the journal bearing shell to cooperatively engage said flanges on said thrust bearing segments.

6. The thrust and journal bearing assembly of claim 1, wherein the flanges on said thrust bearing segment are chamfered at their terminal end to facilitate engagement with said journal bearing shell.

7. The thrust and journal bearing assembly of claim 1, wherein the amount of deflection allowed to permit the snap fit of the thrust bearing segment to the journal shell is determined according to the formulae:
S_{yp}=Mc/I
c=h/2
M_{yp}=S_{yp}I/c
l=πdₘ/4
P_{yp}=M_{yp}/l
y_{yp}=P_{yp}l³/3EI
wherein
S_{yp} is the yield point stress
M is the moment
c is ½ the height
I is the moment of inertia related to a rectangular section of the thrust
bearing segment
h is the height
l is the length
dₘ is the mean diameter
P_{yp} is the force at yield point
y_{yp} is the deflection at yield point
E is the modulus of elasticity, and

8. The thrust and journal bearing assembly of claim 1, wherein the amount of deflection allowed to permit the snap fit of the journal shell to the thrust bearing segment is determined according to the formula:
y_{yp}=P_{yp}l³/3EI
wherein
y_{yp} is the deflection;
I is the moment of inertia;
l is the length; and
E is the modulus of elasticity.

9. A thrust and journal bearing assembly for use in machined surfaces of an engine cylinder block, comprising:
a) at least two arcuate thrust bearing segments, each having an outer arcuate surface and an inner arcuate surface in spaced concentric relationship to each other and separated by a sidewall extending substantially unbroken therebetween to define a thrust bearing segment body; each said thrust bearing body having a length terminating in opposing first and second ends, a width and a height; each said thrust bearing segment outer arcuate surface having an outer diameter; each said thrust bearing segment inner arcuate surface having an inner diameter less than said thrust bearing segment outer diameter; said inner arcuate surface equipped with at least one body flange extending therefrom opposite said outer arcuate surface, said arcuate thrust bearing segment equipped with a first flange at said first end, and a second flange at said second end;
b) an arcuate journal bearing shell having an outer arcuate surface and an inner arcuate surface in spaced concentric relationship to each other and separated by a sidewall extending substantially unbroken therebetween to define a journal bearing segment body; said journal body segment having a length terminating in opposing first and second ends, a width and a height; said journal bearing segment outer arcuate surface having an outer diameter less than the outer diameter of the thrust bearing and less than the inner thrust bearing diameter; said journal bearing segment inner arcuate surface having an inner diameter less than said journal bearing segment outer diameter wherein a lower perimeter is formed by the intersection of the journal bearing shell sidewall and the journal sidewall; said journal bearing body equipped with slots positioned along the length of said journal body oriented to cooperatively engage said flanges on each said thrust bearing; said journal and thrust bearing being elastically deformable; said slots formed along the perimeter of the journal bearing shell to cooperatively engage said flanges on said thrust bearing segments;
whereby, said thrust segments may be snap fit onto said journal bearing and the flanges cooperate with the slots to locate the thrust bearing in relation to the journal bearing.

10. The thrust and journal bearing assembly of claim 9, wherein said thrust bearing body flange is located midpoint along said thrust bearing body length.

11. The thrust and journal bearing assembly of claim 9, wherein the flanges on said thrust bearing segment are chamfered at their terminal end to facilitate engagement with said journal bearing shell.
